(19) United States
(12) Patent Application Publication
(10) Pub. No.: US 2010/0271979 A1
(43) Pub. Date: Oct. 28, 2010

(54) Methods To Facilitate Automatic System Configuration

(75) Inventor: Philippe Godin, Viroflay (FR)

Correspondence Address: Docket Administrator - Room 3D-201E;Alcatel-Lucent USA Inc., 600-700 Mountain Avenue, Murray Hill, NJ, 07974, US

(73) Assignee: Alcatel-Lucent USA Inc., Murray Hill, NJ (US)

(21) Appl. No.: 12/729,954

(22) Filed: Mar. 23, 2010

Related U.S. Application Data
(60) Provisional application No. 61/214,683, filed on Apr. 27, 2009.

(51) Int. Cl. H04L 12/28

(52) U.S. Cl. 370/255

(57) ABSTRACT

An Evolved Packet Core/Mobility Management Entity (EPC/MME) and evolved Node B (eNB) automatically provide a list of key capabilities or features they each support as soon as possible via their shared interface. Therefore, the MME and eNB are each aware of the supported features of the other and what corresponding procedures each can trigger during normal operation. By extension, the approach involves a similar mechanism between peer eNBs over their shared interface. Thus, key capabilities or features supported by the MMEs and/or eNBs are shared to enhance interoperation.

### REFERENCE(S) TO RELATED APPLICATION(S)

The present application claims priority from a provisional application, Ser. No. 61/214683, entitled “METHOD AND APPARATUS FOR AUTO-CONFIGURATION,” filed Apr. 27, 2009, which is commonly owned and incorporated herein by reference in its entirety.

### FIELD OF THE INVENTION

The present invention relates generally to communication systems and, in particular, to facilitating automatic configuration of devices within communication systems.

### BACKGROUND OF THE INVENTION

In early deployments of Long Term Evolution (LTE), not all features will be supported by all the equipment vendors. The set of features that different evolved Node B (eNB) and/or different Evolved Packet Core/Mobility Management Entity (EPC/MME) vendors will support will likely differ from one vendor to another within the same system. Thus, new techniques to address this inter-operability challenge are needed.

### BRIEF DESCRIPTION OF THE DRAWINGS

FIG. 1 is a block diagram depiction of a Mobility Management Entity (MME) and two evolved Node Bs (eNBs), in accordance with multiple embodiments of the present invention.

FIG. 2 is a messaging flow diagram involving an evolved Node B (eNB) and a Mobility Management Entity (MME), in accordance with multiple embodiments of the present invention.

FIG. 3 is a messaging flow diagram involving two evolved Node Bs (eNBs), in accordance with multiple embodiments of the present invention.

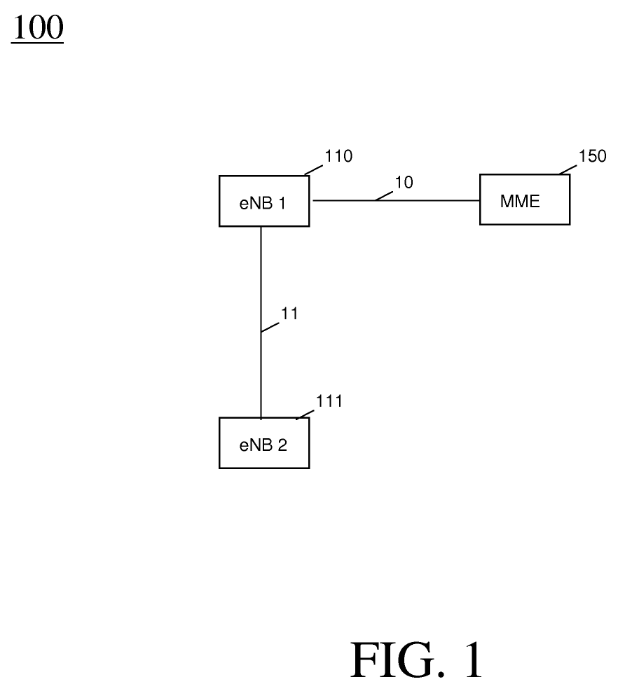

Specific embodiments of the present invention are disclosed below with reference to FIGS. 1-3. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic and/or messaging flow diagrams above are described and shown with reference to specific steps performed and/or messaging communicated in a specific order, some of these steps and/or messaging may be omitted or some of these steps and/or messaging may be combined, sub-divided, or reordered without departing from the scope of the claims. Thus, unless specifically indicated, the order and grouping of steps and/or messaging is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

In Long Term Evolution (LTE), there is currently no automatic means for an evolved Node B (eNB) to determine if a certain feature or a certain capability is supported by the Evolved Packet Core/Mobility Management Entity (EPC/MME) and conversely for the MME to determine if a certain feature or a certain capability is supported by the eNB. However, some features require that both the EPC and the eNB support certain functions for those features to work end-to-end. For example, an eNB may need to know whether the MME is able to send RIM messages (i.e., supports the corresponding core network interface), to support connection to a CDMA2000 system or to support a self-organizing network (SON) Configuration Transfer.

The present solution to this problem is to make all the eNBs in the network aware of EPC capabilities by configuration and conversely to make all the MMEs aware of the eNB capabilities by configuration. The effort to configure such capabilities in the eNBs and the EPCs represents a substantial burden to the operators of these networks.

An approach proposed herein is to automatically provide a list of key capabilities or features supported by the EPC (respectively the eNB) as soon as possible via their S1 interface. Therefore, during setup or as soon as the S1 interface becomes operational, the eNB (respectively the MME) is made aware of those supported features and whether it can trigger corresponding procedures during system operation. By extension, the approach involves a similar mechanism over the X2 interface, i.e., that an eNB supplies to a peer eNB the list of key features it supports (e.g., IMS emergency call support, etc.) during setup or as soon as the X2 interface becomes operational. Thus, key capabilities or features supported by the MMEs and/or eNBs are shared to enhance interoperation.

The present invention can be more fully understood with reference to FIGS. 1-3. FIG. 1 is a block diagram depiction of a Mobility Management Entity (MME) and two evolved Node Bs (eNBs), in accordance with multiple embodiments of the present invention. It should be understood that wireless communication systems typically include a plurality of mobile units, a plurality of network nodes, and additional equipment; however, only network nodes (eNBs 110-111) and Mobility Management Entity (MME) 150 are depicted in diagram 100 for the sake of clarity.

MME 150 and eNB 110 communicate via interface 10, while eNBs 110-111 communicate via interface 11. Interfaces 10-11 are based on standard interfaces such as 3GPP's S1 and X2 interfaces, respectively, with modifications as described herein.

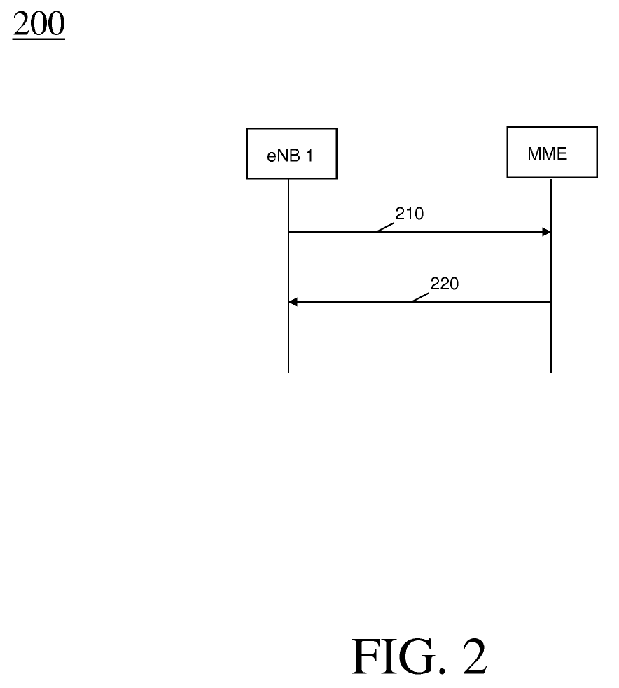

FIG. 2 is a messaging flow diagram involving an evolved Node B (eNB) and a Mobility Management Entity (MME), in accordance with multiple embodiments of the present invention. In diagram 200, the eNB sends to the MME an indication 210 of which capabilities, from a list of eNB capabilities, are supported by the eNB. Depending on the embodiment, the list of eNB capabilities may include one or more of the following: support for RIM messaging, support for CDMA2000 connectivity, and support for self-organizing network (SON) functionality.

The MME also sends an indication 220 of which capabilities, from a list of MME capabilities, are supported by the MME. Depending on the embodiment, the list of MME capabilities may include one or more of the following: support for RIM messaging, support for CDMA2000 connectivity, and support for self-organizing network (SON) functionality.

Indications 210 and 220 may be sent as new messages via the S1 interface or incorporated into existing S1 interface messaging. Either indication 210 or 220 may take the form of a new information element, perhaps including a bit string in which the value of each bit, a 0 or 1, indicates whether the corresponding functionality is supported or not. For example, indication 220 may be included in an S1 SETUP RESPONSE message as a new information element. Also, although diagram 200 depicts indication 210 being sent before indication 220, they need not be sent in this order.

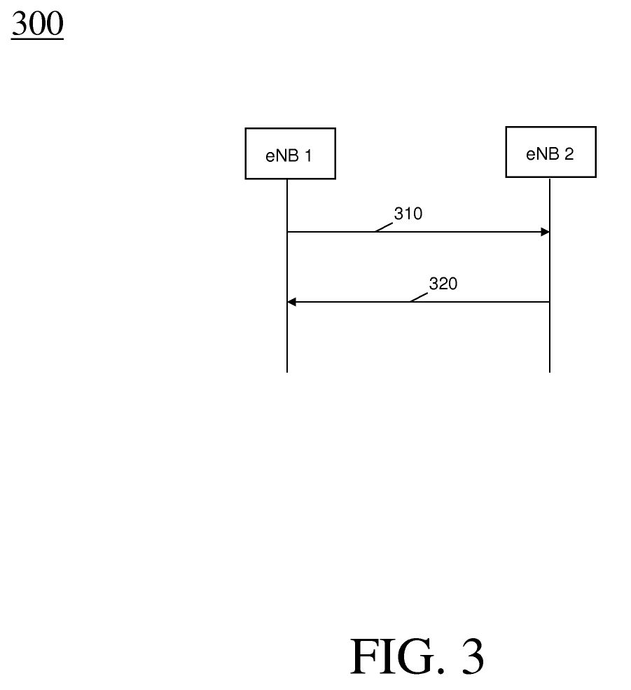

FIG. 3 is a messaging flow diagram involving two evolved Node Bs (eNBs), in accordance with multiple embodiments of the present invention. In diagram 300, the eNBs exchange indications 310 and 320 of which capabilities, from a list of eNB capabilities, are supported by the sending eNB. As an example, the list of eNB capabilities may include IMS emergency call support.

Indications 310 and 320 may be sent as new messages via the X2 interface or incorporated into existing X2 interface messaging. Either indication 310 or 320 may take the form of a new information element, perhaps including a bit string in which the value of each bit, a 0 or 1, indicates whether the corresponding functionality is supported or not. Also, although diagram 300 depicts indication 310 being sent before indication 320, they need not be sent in this order.

Embodiments such as those described above can save an operator configuration costs related to the operator's eNBs and EPCs. In addition, when considering extensions due to Home (e) NodeB deployment, the otherwise required configuration costs can become even larger and thus the savings brought by embodiments proposed herein even greater. Embodiments proposed herein can also facilitate upgrade operations in the network when the capabilities supported by equipment changes.

Thus, embodiments proposed herein replace configuration tasks with automatic learning of key capabilities/features supported by other network equipment, in particular in a multi-vendor environment. Corresponding OPEX savings would therefore be expected.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method to facilitate automatic system configuration comprising:
sending, by an evolved Node B (eNB) to a Mobility Management Entity (MME) via an S1 interface, an indication of which capabilities from a list of eNB capabilities are supported by the eNB;
receiving, by the evolved Node B (eNB) from the Mobility Management Entity (MME) via the S1 interface, an indication of which capabilities from a list of MME capabilities are supported by the MME.

2. The method as recited in claim 1, wherein the list of eNB capabilities comprises at least one of:
supports RIM messaging,
supports CDMA2000 connectivity, and
supports self-organizing network (SON) functionality.

3. The method as recited in claim 1, wherein the list of MME capabilities comprises at least one of:
supports RIM messaging,
supports CDMA2000 connectivity, and
supports self-organizing network (SON) configuration transfer.

4. The method as recited in claim 1, wherein sending by the eNB to the MME via the S1 interface comprises
sending by the eNB to the MME during setup of the S1 interface.

5. The method as recited in claim 1, wherein receiving by the eNB from the MME via the S1 interface comprises
receiving by the eNB from the MME during setup of the S1 interface.

6. The method as recited in claim 5, wherein the indication of which capabilities from the list of MME capabilities are supported by the MME is included in an S1 SETUP RESPONSE message.

7. A method to facilitate automatic system configuration comprising:
sending, by a Mobility Management Entity (MME) to an evolved Node B (eNB) via an S1 interface, an indication of which capabilities from a list of MME capabilities are supported by the MME;
receiving, by the Mobility Management Entity (MME) from the evolved Node B (eNB) via the S1 interface, an indication of which capabilities from a list of eNB capabilities are supported by the eNB.

8. The method as recited in claim 7, wherein the list of eNB capabilities comprises at least one of:
supports RIM messaging,
supports CDMA2000 connectivity, and
supports self-organizing network (SON) functionality.

9. The method as recited in claim 7, wherein the list of MME capabilities comprises at least one of:
supports RIM messaging,
supports CDMA2000 connectivity, and
supports self-organizing network (SON) configuration transfer.

10. The method as recited in claim 7, wherein sending by the MME to the eNB via the S1 interface comprises
sending by the MME to the eNB during setup of the S1 interface.

11. The method as recited in claim 7, wherein receiving by the MME from the eNB via the S1 interface comprises
receiving by the MME from the eNB during setup of the S1 interface.

12. The method as recited in claim 11, wherein the indication of which capabilities from the list of MME capabilities are supported by the MME is included in an S1 SETUP RESPONSE message.

13. A method to facilitate automatic system configuration comprising:
sending, by a first evolved Node B (eNB) to a second evolved Node B (eNB) via an X2 interface, an indication of which capabilities from a list of eNB capabilities are supported by the first eNB;
receiving, by the first evolved Node B (eNB) from the second evolved Node B (eNB) via the X2 interface, an indication of which capabilities from the list of eNB capabilities are supported by the second eNB.

14. The method as recited in claim 13, wherein the list of eNB capabilities comprises IMS emergency call support.

15. The method as recited in claim 13, wherein sending by the first eNB to the second eNB via the X2 interface comprises
sending by the first eNB to the second eNB during setup of the X2 interface.

16. The method as recited in claim 13, wherein receiving by the first eNB from the second eNB via the X2 interface comprises
receiving by the first eNB from the second eNB during setup of the X2 interface.
